(19) United States
(12) Patent Application Publication
(10) Pub. No.: US 2006/0080807 A1
(43) Pub. Date: Apr. 20, 2006

(54) Rotary type hinge unit

(76) Inventor: Su Man Gwag, Bucheon-si (KR)

Correspondence Address: BAKER & DANIELS LLP, 300 NORTH MERIDIAN STREET, SUITE 2700, INDIANAPOLIS, IN, 46204, US

(21) Appl. No.: 11/252,131

(22) Filed: Oct. 17, 2005

(30) Foreign Application Priority Data
Oct. 20, 2004 (KR) 20-2004-0029616

(51) Int. Cl. E05D 5/02

(52) U.S. Cl. 16/388

(57) ABSTRACT

The rotary type hinge unit that has a stand-hinge body with a circular hole, the stand-hinge body fixed to a stand of a flat panel display device; a leaf spring placed within the circular hole of the stand-hinge body; and a panel-hinge body fixed to a fiat panel display panel and rotated as the flat display panel is rotated, wherein the panel-hinge body has a folding portion that passes through the circular hole of the stand-hinge body and surrounds the leaf spring such that the leaf spring is fixed to the folding portion, wherein the panel-hinge body comprises a plurality of slots that contact with a base end of the folding portion.

This application claims the benefit of Korean Utility Model Application No. 2004-0029616, filed on Oct. 20, 2004 in Korea, which is hereby incorporated by reference for all purposes as if fully set forth herein.

### BACKGROUND OF THE INVENTION

1. Field of the Invention

The present invention relates to a hinge unit, and more particularly to a rotary type hinge unit used in a flat panel display device.

2. Discussion of the Related Art

Generally, a flat panel display device such as liquid crystal display(LCD) monitor, as shown in FIG. 1, comprises a display panel 10, a stand 20 supporting the display panel 10 and a hinge unit 30 that connects the display panel 10 to the stand 20 such that the display panel 10 rotates up and down or right and left.

Herein, the hinge unit 30 comprises a panel-hinge body 32 fixed to the display panel 10, a stand-hinge body 36 fixed to the stand 20 and a shaft 34 that connects the panel-hinge body 32 to the stand-hinge body 36, as shown in FIG. 2. The shaft 36 is a rotation center in case the hinge unit 30 and the display panel 10 rotate with respect to each other.

The related art hinge unit 30 rotates using the shaft 34 as a rotation center. Accordingly, the shaft 34 is long enough to rotate the hinge unit 30, which causes an increase of the hinge unit 30 in size or volume and prevents a miniaturization of the display panel device.

In order to overcome those problems in the related art hinge unit 30, Korean Utility Model Registration No. 327069 (the present inventor) discloses a rotary type hinge unit.

As shown in FIG. 3, which is a perspective view showing the rotary type hinge unit in the flat panel display device, the rotary type hinge unit has a stand-hinge body 40 fixed to the stand 20 (of FIG. 1), a circular leaf spring 42, and a panel-hinge body 44 fixed to the display panel 10 (of FIG. 1).

The leaf spring 42 is a circular element having a spring-hole, preferably circular spring-hole, in the center thereof and has a slant portion in a periphery of the spring-hole for elasticity. It will be explained in detail about the coupling scheme among the elements in the related art rotary type hinge unit.

The stand-hinge body 40 has a circular hole with the same diameter as the spring hole of the leaf spring 42 and is fixed to the stand 20 (of FIG. 1).

Besides, the panel-hinge body 44 has a folding portion 41 that has a diameter smaller than that of the circular hole of the stand-hinge body 40, as shown in FIG. 4, which is a perspective view showing a panel-hinge body 44 of the related art rotary type hinge unit of FIG. 3. The panel-hinge body 44 is fixed to the display panel 10 (FIG. 1). The folding portion 41 of the panel-hinge body 44 has a height such that a top surface of the folding portion 41 is higher than a top surface of the leaf spring 42 placed onto the stand-hinge body 40. After the folding portion 41 is inserted through the circular hole of the stand-hinge body and the spring-hole of the leaf spring 42 sequentially, the folding portion 41 is folded by press means, thereby fixing the stand-hinge body 40 and the leaf spring 42 simultaneously. Accordingly, the stand-hinge body 40 is inserted into the folding portion 41 of the panel-hinge body 44 and the leaf spring 42 is placed on the stand-hinge body 44. The folding portion 41, which is longer than the thickness of the leaf spring 42, is raised or protruded above the leaf spring 42. Then, the folding portion 41 is folded toward to the leaf spring 42 by press means and the likes.

The folding portion 41 of the panel-hinge body 44 fixes the leaf spring 42 and the stand-hinge body 40 simultaneously in the above related art rotary type hinge unit. In addition, the panel-hinge body 44 is fixed to the display panel 10 (of FIG. 1) and the stand-hinge body 40 is fixed to the stand 20 (of FIG. 1).

In accordance with the related art rotary type hinge unit above, when a user gives the display panel 10 a turning force equal to or greater than the force applied to the panel-hinge body 44 and the stand-hinge body 40 by the leaf spring 42, the display panel 10 rotates up and down or right and left. As a user quits applying a turning force, the panel-hinge body 44 comes in contact with the stand-hinge body 40 by elastic force of the leaf spring 42, thereby generating a frictional force between the panel-hinge body 44 and the stand-hinge body 40 so that the display panel 10 can maintain a fixed state.

Since the related art rotary type hinge unit comprises only thin plate-type elements such as the leaf spring 42, the panel-hinge body 44, the stand-hinge body 40 and the likes, it can contribute to the miniaturization of the display device such as LCD monitor.

Besides, in case of manufacturing the related art rotary type hinge unit, the folding portion 41 is formed on the panel-hinge body 44 by applying punching and press process to the flat carrier plate such that the folding portion with a predetermined diameter is protruded.

In the related art rotary type hinge unit, since the folding portion 41 functions as a connector and a rotation axis of the panel-hinge body 44 and the stand-hinge body 40, the operation performance depends on distortion of circular shape.

However, the press process is performed by pressing the carrier plate with a mold having a circular protrusion with a predetermined diameter, so that the center of the carrier plate can be protruded cylindrically. In the course of the press process, a part of the folding portion 41 which is pressed by the circular protrusion of the mold is distorted.

In other words, the base end of the folding portion 41 is transformed to vertically extensive shape as well as to horizontally cylindrical shape in the course of forming the folding portion 41 by pressing the part of the flat carrier plate. In this case, the degree of the horizontally directed transformation is not uniform so that the folding portion 41 can not maintain a genuine or perfect circular shape.

Besides, when the folding portion 41, which results from pressing the flat carrier plate, does not have a genuine circular shape, both the leaf spring 42 and the stand-hinge body 40 which surround the folding portion 41 are not properly operated to rotate. Accordingly, the operation performance of the hinge unit is deteriorated.

### SUMMARY OF THE INVENTION

Accordingly, the present invention is directed to a rotary type hinge unit that substantially obviates one or more of problems due to limitations and disadvantages of the related art.

It is an object of the present invention is to provide a rotary type hinge unit that adopts a panel-hinge body with a structure of forming the folding portion conveniently such that it is possible to enhance the productivity and the operation performance.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, in one aspect, the present invention provides a rotary type hinge unit comprises a stand-hinge body with a circular hole, the stand-hinge body fixed to a stand of a flat panel display device; a leaf spring placed within the circular hole of the stand-hinge body; and a panel-hinge body fixed to a fiat panel display panel and rotates with respect to the stand-hinge body, wherein the panel-hinge body has a folding portion that passes through the circular hole of the stand-hinge body and surrounds the leaf spring such that the leaf spring is fixed to the folding portion, wherein the panel-hinge body comprises a plurality of slots that contact a base end of the folding portion.

Preferably, the slots are arranged substantially equidistantly on the panel-hinge body, and more preferably, the slots are arranged circularly on the panel-hinge body with equidistance.

In another aspect, the present invention provides a method of preparing a rotary type hinge unit, the method comprises the steps of (a) punching a carrier plate to form slots; (b) pressing the carrier plate to form a folding portion, thereby forming a panel-hinge body; and (c) inserting the folding portion of the panel-hinge body to a spring-hole of a leaf spring and a circular hole of a stand-hinge body in order to fix the leaf spring and the stand-hinge body.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a general flat panel display device;

FIG. 2 is a perspective view showing a related art hinge unit used in the flat panel display device;

FIG. 3 is a perspective view showing related art rotary type hinge unit in the flat panel display device;

FIG. 4 is a perspective view showing a panel hinge body of the related art rotary type hinge unit in FIG. 3;

FIG. 5 is a perspective view showing a panel hinge body of a rotary type hinge unit in accordance with the present invention; and

FIG. 6 is a perspective view showing a carrier plate of the panel hinge body in the rotary type hinge unit in accordance with the present invention.

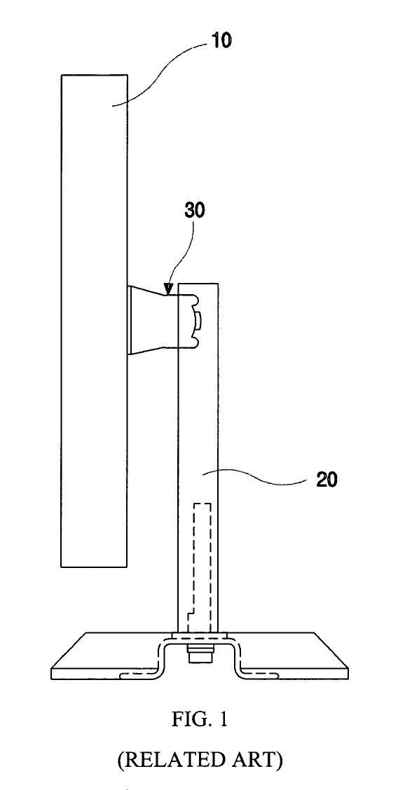

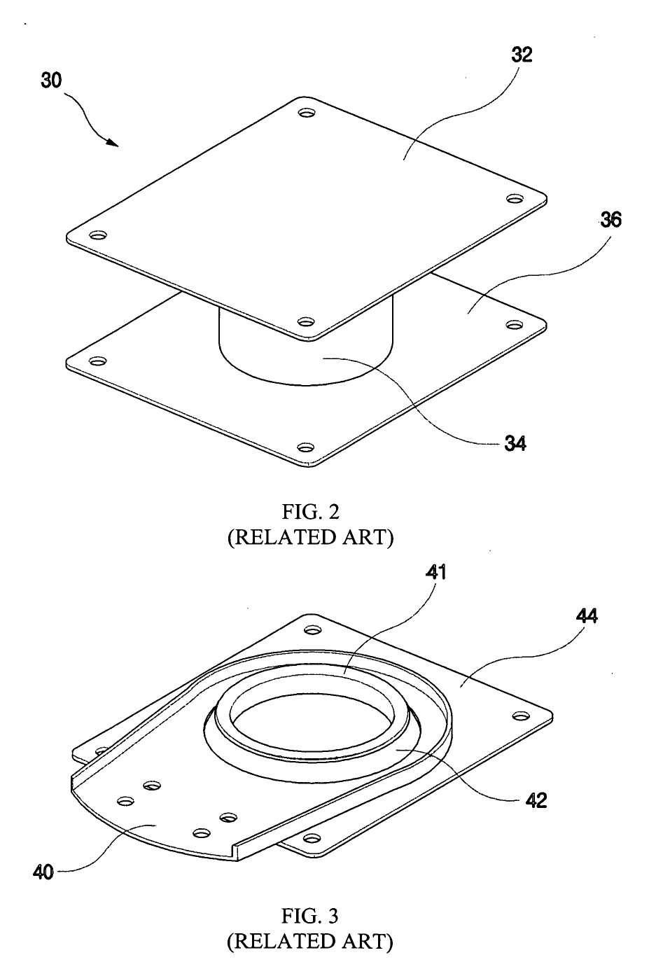

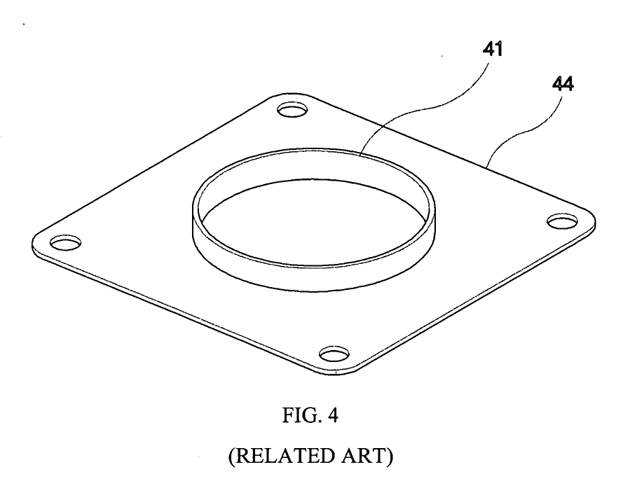

### DETAILED DESCRIPTION OF THE ILLUSTRATED EMBODIMENTS

Reference will now be made in detail to the illustrated embodiment of the present invention, which is illustrated in the accompanying drawings.

The panel hinge body of the rotary type hinge unit in accordance with the present invention consists of “stress reduction structure” where a genuine or perfect circular shape of a folding portion is easily obtained.

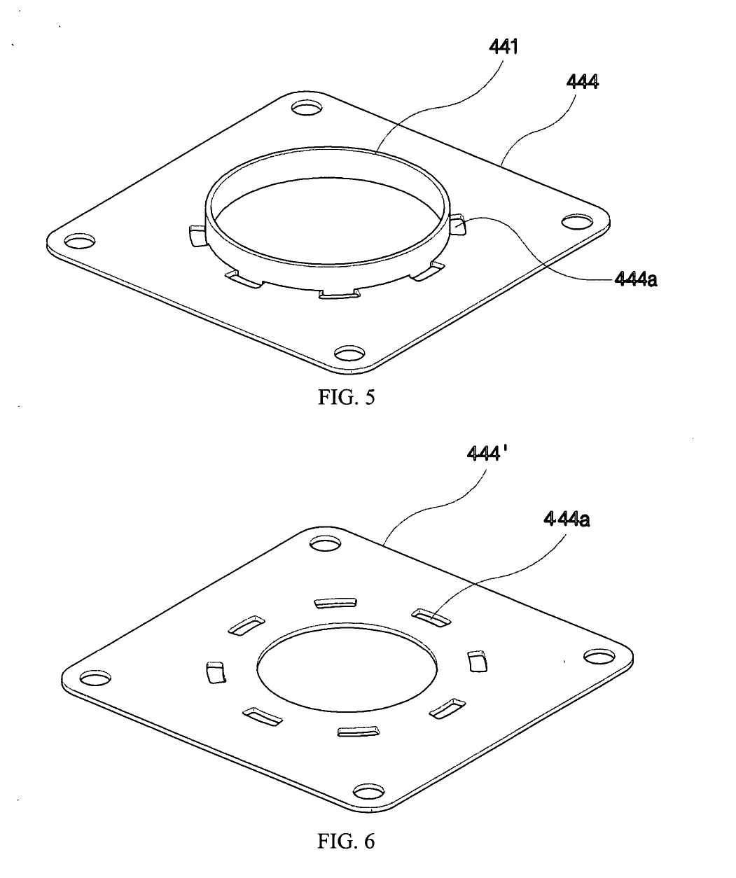

The “stress reduction structure” is a structure where a stress or resistance of the stand-hinge body due to the protrusion of the mold is released in the course of press process. In order to release the stress, a plurality of slots 444a are arranged, preferably equidistantly, along a periphery of the base end of the folding portion 441 on the panel-hinge body 444, as shown in FIG. 5, which is a perspective view showing a panel hinge body of a rotary type hinge unit in accordance with the present invention. Each of the slots contacts to the outer base end of the folding portion 441.

Each of the slots 444a is arranged circularly so that a virtual line connecting centers of the slots along the base end of the folding portion 441 forms a perfect circle. As shown in FIG. 6, each slot 444a is formed on the carrier plate 444′ by means of punching process prior to forming the folding portion 441 on the carrier plate 444′.

In other words, after forming plural slots 444a on the carrier plate 444′ to obtain a “stress reduction structure”, the folding portion 441 is formed on the carrier plate 444′ by press process, as shown in FIG. 6, which is a perspective view showing a carrier plate of the panel hinge body in the rotary type hinge unit in accordance with the present invention. In this case, it is possible to prevent a part of the folding portion 441 from being distorted because the each slot 444a releases a stress generated at the base end of the folding portion 441 in the course of press process.

Accordingly, the base end of the folding portion 441 is transformed naturally or smoothly along the horizontal direction when the base end of the folding portion 441 is transformed from the flat plate shape to the cylindrical shape. As a result, the folding portion 441 has a perfect circular shape in a cross-sectional view.

Therefore, both the leaf spring 42 and the stand-hinge body 40, which contact to the folding portion 441, rotates smoothly with respect to the folding portion 441.

Besides, it is possible to mold the folding portion 441 with a weaker force compared to the related art one because of the friction reduction of the pressed portions in the course of pressing the folding portion 441. Accordingly, the efficiency of press process is improved.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A rotary type hinge unit, comprising:
a stand-hinge body with a circular hole, the stand-hinge body fixed to a stand of a flat panel display device;
a leaf spring placed within the circular hole of the stand-hinge body; and
a panel-hinge body fixed to a fiat panel display panel and rotates with respect to the stand-hinge body, wherein the panel-hinge body has a folding portion that passes through the circular hole of the stand-hinge body and surrounds the leaf spring such that the leaf spring is fixed to the folding portion,
wherein the panel-hinge body comprises a plurality of slots that contact a base end of the folding portion.

2. The rotary type hinge unit according to claim 1, wherein the plurality of slots are arranged substantially equidistantly on the panel-hinge body.

3. The rotary type hinge unit according to claim 1, wherein the plurality of slots are arranged circularly on the panel-hinge body.

4. A process of producing a rotary type hinge unit, the method comprising:
(a) punching a carrier plate to form slots;
(b) pressing the carrier plate to form a folding portion, thereby forming a panel-hinge body; and
(c) inserting the folding portion of the panel-hinge body to a spring-hole of a leaf spring and a circular hole of a stand-hinge body in order to fix the leaf spring and the stand-hinge body.
